(19) United States
(12) Patent Application Publication
(10) Pub. No.: US 2004/0236948 A1
(43) Pub. Date: Nov. 25, 2004

(54) Regulated issuance of digital certificates

(76) Inventor: Brian Bernard McKeon, Sydney (AU)

Correspondence Address: Brian McKeon, 24 Holdsworth Av, St. Leonards, Sydney, 2065, AU

(21) Appl. No.: 10/767,529

(22) Filed: Jan. 29, 2004

(30) Foreign Application Priority Data
Jan. 31, 2003 (AU) 2003900413

(51) Int. Cl. H04L 9/00

(52) U.S. Cl. 713/175

(57) ABSTRACT

This invention allows a Certifying Authority (CA) in a Public Key Infrastructure (PKI) to allow a sub-CA to issue a pre-determined number of certificates without excessive overhead by the former CA. The regulation is performed by means of a security token that includes a count of the number of certificates issued by the sub-CA.

### INTRODUCTION

This invention relates to a system and method for regulation of the issuance of digital certificates.

### BACKGROUND

Industry is increasingly making use of digital certificates to implement electronic authentication of entities, which could be individuals, organisations, computers etc. Public Key Infrastructure [PKI], [1] is a system whereby central agencies are given the role of Certifying Authorities (CAs) and these CAs produce certificates for sub-entities. Such certificates certify the keys of each entity and enable entities to communicate with confidence as to the authenticity or confidentiality of such communication.

Often a national agency will perform the role of a central or root CA and certify sub-CAs which then certify end-users or even lower levels of CAs. Certificates are commonly based on the X509 standard [1] and this standard allows a certificate to state if the certified entity is authorised to certify other entities.

Issuance of certificates by a root CA involves significant cost to provide security mechanisms that give confidence that fraudulent certificates are not produced. This cost is recovered by sales of certificates. If a certificate is for a CA that will be issuing certificates then the price of this CA's certificate will be related to the number of sub-certificates that will be produced.

For larger corporations, the numbers of certificates can be accounted for using standard business reporting processes. For smaller corporations, this mechanism is not economic.

### SUMMARY OF THE INVENTION

The present invention describes a method whereby the issuance of certificates by a CA can be regulated with a security mechanism that does not require additional business processes.

The CA is provided with a security token containing the certifying key of the CA and a certificate, Cx, that authorises that CA to issue certificates for other entities, typically within the organisation represented by the CA. The security token also includes the public key of the issuer to enable validation of certificates presented to the token. The security token is tamper-resistant to prevent copying of the private certifying key or tampering with the issuer public key or other stores within the token.

The security token also includes a counter of the number of times that the certifying key is used to certify information presented to the token. The security token also includes a threshold count. Once the certifying counter reaches the threshold count, the certifying key mechanism is disabled.

If a new certificate, Cy, is received for the CA the security token will confirm that the certificate is valid using the stored certifying key. If the certificate, Cy, is valid and the certificate is newer than the existing certificate, Cx, then Cy will be used to replace Cx and the count of issued certificates will be cleared. The loading of the new certificate, Cy, thereby enables issuance of further certificates by the token.

An alternative to checking that Cy is newer than Cx is that the token can maintain a list of the identity of previously-loaded Cx. The new Cy would be checked against that list to prevent reload of an already-used certificate.

### DETAILED DESCRIPTION OF THE PREFERRED EMBODIMENT

The following embodiment is based on a security token that is based on a smart card running the MULTOS[2] operating system and with a proprietary application, AP. This specific embodiment concerns the case where a CA, CAₑₓₜ, wishes to authorise a small organisation to issue certificates for individuals within that organisation. CAₑₓₜ will be authorising a CA within the small organisation, CAᵢₙₜ, to issue certificates to individuals associated with the organisation.

The MULTOS application provides a standard ISO7816 command/response interface [3,4] which implements the following commands (amongst other commands):

LOGIN—a user or security office can present a command containing a PIN and, if valid, the PIN will unlock the card. If a pre-determined number of invalid PINs are presented sequentially, the card will then ignore further commands ie will be locked.

LOAD_KEY—this command is available when a security officer is logged-in and is intended for card production. This command is used by CAₑₓₜ to load the keys intended for CAᵢₙₜ. These keys will then be used by CAᵢₙₜ to certify (issue) other certificates. The LOAD_KEY operation resets the loaded certificate ‘not-before’ date. The LOAD_KEY command is also used to load the public key of CAₑₓₜ so that subsequent certificates issued by CAₑₓₜ can be verified.

LOAD_CERTIFICATE—the user or security officer must be logged-in. This command is used during card production and over the life of the card. The certificate to be loaded is issued by CAₑₓₜ and the public key of CAₑₓₜ that is within the card is used to verify that the certificate is authentic. The certificate references a specified Organisation and Organisational Unit in the X.509 Certificate subject name, see [1], p57. The X.509 standard also specifies a ‘not-before’ date, which specifies the date when the certificate becomes valid. If this date is older than the ‘not-before’ date of the existing certificate then the certificate load will fail as the certificate may have been used previously by the card to issue the allocated number of certificates and this may be an attempt to reload this certificate.

GENERATE_CERTIFICATE —The card application is presented with the core certificate information of user name and email address. If the counter of issued certificates exceeds the maximum count allowed, the command will fail. Otherwise the counter is incremented and the card will construct and sign a certificate using the supplied user data and the preset Organisation and Organisational Unit data and return the certificate as response data. The smart card does not check the ‘not-before’ or ‘not-after’ X. 509 dates prior to issuing a certificate, as the smart card has no internal clock. This check is not essential as it is possible, and is an expected requirement, for any recipient application to verify that the validity dates of certificates in a chain of certificates are valid.

Although the invention has been described with reference to specific embodiments of the invention, it will be appreciated by those skilled in the art that it may be embodied in many other forms.

What is claimed is:

1. A method for providing a cryptographic ticket to a trusted module allowing that module to issue a pre-determined number of public-key certificates.

2. A computer system based on the method of 1.

3. A computer system based on the method of claim 1 where the trusted module is a hardware token such as a USB token or a smartcard.

4. A method based on claim 1 where the cryptographic ticket is a public-key or private-key certificate.

5. A computer system based on the method of 4.

6. A computer system based on the method of claim 4 where the trusted module is a hardware token such as a USB token or a smartcard.

7. A method based on claim 1 where the pre-determined number of certificates that can be issued is determined by information within the provided cryptographic ticket.

8. A computer system based on the method of 7.
A computer system based on the method of claim 7 where the trusted module is a hardware token such as a USB token or a smartcard.
